(19) United States
(12) Patent Application Publication
(10) Pub. No.: US 2025/0196173 A1
(43) Pub. Date: Jun. 19, 2025

(54) COATING DEVICE AND COATING LINE FOR OVERTURNED FORMED FIBER CONTAINER

(71) Applicant: Stora Enso OYJ, Helsinki (FI)

(72) Inventors: Xionggang Li, Hebei (CN); Yunbo Wang, Hebei (CN); Yan Wang, Hebei (CN); Kai Zhao, Hebei (CN)

(73) Assignee: Stora Enso OYJ, Helsinki (FI)

(21) Appl. No.: 18/847,469

(22) PCT Filed: Mar. 15, 2023
(86) PCT No.: PCT/IB2023/052513

§ 371 Date: Sep. 16, 2024

(30) Foreign Application Priority Data
Mar. 17, 2022 (CN) 202220585269.0

(51) Int. Cl. B05B 13/06

(52) U.S. Cl. CPC B05B 13/0645

(57) ABSTRACT

The disclosure provides coating device and coating line for overturned formed fiber container. The coating device for overturned formed fiber container comprises a support configured to support the rim of the container at its upper surface, a pressing block disposed above the support and configured to press the container at its bottom surface; and a spray nozzle configured to spray a solution to the inner wall of the container; wherein, the support is configured to be able to rotate relative to the spray nozzle to drive the container to rotate. With the rotation of the fiber container, the solution sprayed by the spray nozzle and attached to the inner wall of the fiber container will spread evenly to form a coating; and moreover, the solution sprayed by the spray nozzle will be blocked by the inner wall of the fiber container and will not splash around, thus will eliminate the problem of environmental pollution, and there is no need to set a closed chamber around, thus will reduce the occupied area of the equipment.

### TECHNICAL FIELD

The disclosure relates to the field of fiber product manufacturing, in particular to a coating device for overturned formed fiber container, and also relates to a coating line.

### BACKGROUND

Fiber containers (such as bowls, plates, pots, bottles, etc.) molded from pulp are widely used in food packaging, which has many advantages such as wide source of raw materials, easy degradation, high strength and so on. The material of fiber container may pollute the food contained therein, and the material of food may also penetrate and damage the fiber container. To solve this problem, one solution is to coat the surface of fiber container with a layer of isolation film (for example, fluorine-free oil repellent).

A known film coating scheme is to put a fiber container in a closed chamber with its opening facing upwards, spray a solution inside the fiber container, and then drive the fiber container to rotate at high speed. Under the centrifugal force, the solution will spread to the whole surface of the fiber container to form an isolation film. In this scheme, since the opening of the fiber container is upward, the isolation solution will splash upward and around, causing pollution problems. Moreover, it is necessary to form a closed chamber around the spraying equipment to prevent the solution from splashing around. This closed chamber usually occupies a large area.

Therefore, it is urgent to provide a coating device and coating line which can reduce pollution and decrease the occupied area in practice.

### SUMMARY

The purpose of the disclosure is to at least solve the problems in the prior art, and to propose a coating device for overturned formed fiber container and a coating line for fiber containers.

In the first aspect, the disclosure provides coating device for overturned formed fiber container, characterized in that, it comprises: a support configured to support the rim of the container at its upper surface; a pressing block disposed above the support and configured to press the container at its bottom surface; and a spray nozzle configured to spray a solution to the inner wall of the container; and wherein, the support is configured to be able to rotate relative to the spray nozzle to drive the container to rotate.

According to this scheme, with the rotation of the fiber container, the solution sprayed by the spray nozzle and attached to the inner wall of the fiber container will spread evenly to form a coating; and moreover, the solution sprayed by the spray nozzle will be blocked by the inner wall of the fiber container and will not splash around, and therefore, the problem of environmental pollution will be eliminated, and there is no need to set a closed chamber around, so that the occupied area of the equipment will be reduced.

Optionally, the support comprises an inner ring, an outer ring and a plurality of connecting rods connecting the inner ring and the outer ring; and wherein the plurality of connecting rods are configured to support the rim of container.

According to this scheme, excess solution can fall through the inside of the inner ring and the space between adjacent connecting rods. Moreover, the fiber container is only supported at the position where the rim of the fiber container contacts the connecting rods, and the coating on the inner wall of the fiber container will not be affected.

Optionally, a guide plate is disposed below the support and configured to rotate synchronously with the support; and wherein the guide plate has a central hole and a guide surface inclined downward the central hole.

According to this scheme, by means of the inclined guide surface, the guide plate can guide the solution to flow downwards.

Optionally, a baffle plate is disposed between the support and the guide plate, covering an outside part of the guide surface.

According to this scheme, the baffle plate can prevent the solution from splashing outwards from the guide surface under the action of centrifugal force.

Optionally, a rotor cylinder is disposed below the guide plate and fixed to the same; the rotor cylinder includes an inner hole which is communicated with the central hole of the guide plate; and the rotor cylinder is rotatably supported on an operating table.

According to this scheme, the rotor cylinder has the function of driving the guide plate, as well as the upper support and the fiber container to rotate, and the function of allowing the upper solution to flow downward and collecting the solution.

According to the scheme, the upper part of the outer wall of the rotor cylinder is provided with a tooth ring which is connected to a driving motor through a toothed belt; the lower part of the outer wall of the rotating cylinder is provided with a bearing, which is located between the rotor cylinder and a mounting plate fixed to the operating table, and the bearing bears the rotor cylinder to rotate relative to the mounting plate and also supports the rotor cylinder in a vertical direction.

According to this scheme, the tooth ring for power input and the bearing for axial and circumferential support are arranged on the same rotor cylinder, which makes the structure compact, makes the performance reliable and allows convenient installation and maintenance.

Optionally, a collecting device is installed onto the lower surface of the operating table, and the internal volume of the collecting device is communicated with the inner hole of the rotor cylinder; and a pump is configured to pump the solution in the collecting device to the spray nozzle.

According to this scheme, the collecting device can collect and recover the excess solution, and the recycling of the solution can be realized under the action of the pump, and thus the economic benefit is improved.

Optionally, a connector is located inside the collecting device with its one end connected to the operating table and the other end connected to the lower end of a rod connected to the spray nozzle, and wherein the rod extends through the inner hole of the rotor cylinder.

According to this scheme, the spray nozzle can be installed in the internal space of the collecting device, and there is no need to provide a complicated spray nozzle installation device outside, and therefore, the overall structure of the equipment is compact.

In the second aspect, the disclosure provides coating line for overturned formed fiber container, which comprises: an upstream station, a coating station and a downstream station; an input device configured to move the container from the upstream station to the coating station; and an output device configured to move the container from the coating station to the downstream station; and wherein the coating device as set forth above is disposed at the coating station.

According to this scheme, since the spraying solution of the coating device does not splash around, there is no need to set a closed chamber around, and thus the whole coating line has a clean and pollution-free the production environment, and occupies small area.

Optionally, the input device includes a vacuum chuck configured to suck and transfer a container from a stack of containers stored in a stacking mechanism; and the output device includes a mechanical arm configured to clamp, transfer and/or overturn the container.

According to this scheme, the vacuum chuck can easily absorb and move the uncoated fiber container. Using the mechanical arm to operate the coated fiber container instead of using the vacuum chuck can avoid the situation that the vacuum chuck sucks the uncured solution on the inner wall of the fiber container and damages the coating.

### BRIEF DESCRIPTION OF DRAWINGS

FIG. 1 is a schematic side view of the coating device of the disclosure;

FIG. 2 is a schematic top view of a support of the coating device;

FIG. 3 is a schematic diagram of the coating line of the disclosure;

FIG. 4 is a schematic view of a two-station coating device;

FIG. 5 is a schematic diagram of the driving mechanism.

### REFERENCE NUMERAL

1 fiber container; 11 rim; 12 bottom; 2 support; 21 inner ring; 22 outer ring; 23 connecting rod; 3 pressing block; 31 positioning rod; 4 spray nozzle; 41 rod; 42 connector; 43 pump; 51 gland; 52 support; 6 guide plate; 61 center hole; 62 guide surface; 7 baffle plate; 8 rotor cylinder; 81 inner hole; 82 outer wall; 83 tooth ring; 84 driving motor; 85 toothed belt; 86 bearing; 9 mounting plate; 10 operating table; 20 collecting device; 101 upstream station; 102 coating station; 103 downstream station; 104 input device; 105 output device; 106 the first rail; 107 vacuum chuck; 108 the second rail; 109 mechanical arm; 110 double-station coating device; 111 driving gear; 112 first gear ring; 113 second gear ring; 114 primary guide wheel; 115 toothed belt; 116 First auxiliary guide wheel; 117 second auxiliary guide wheel; 118 stacking mechanism; 801 a first rotor cylinder; 802 second rotor cylinder.

### DETAILED DESCRIPTION

In order to make the purpose, scheme and advantages of the technical scheme of the disclosure clearer, the technical solution of the embodiment of the disclosure will be described clearly and completely with the attached drawings of the specific embodiment of the disclosure. Unless otherwise specified, the terms used herein have the ordinary meaning in the art. Like reference numerals in the drawings represent like parts.

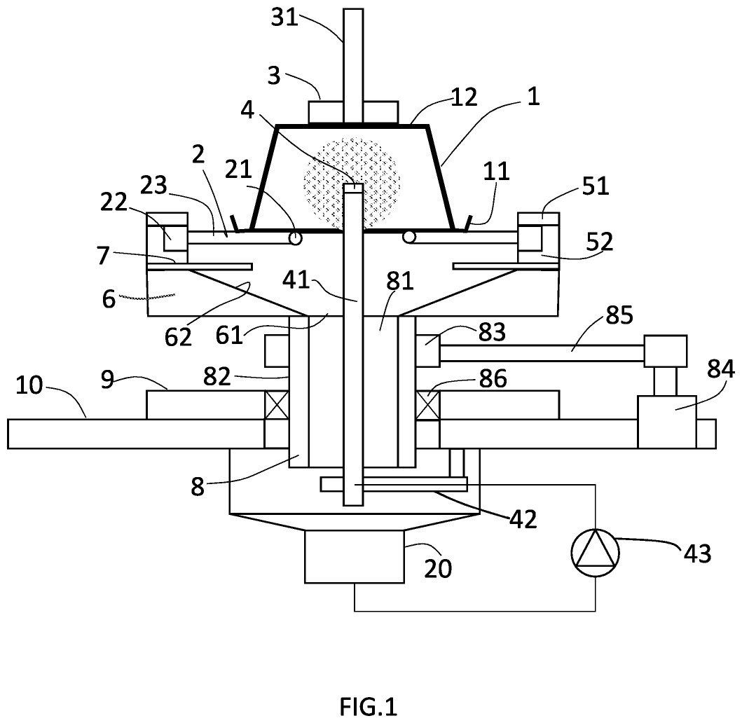

FIG. 1 shows a schematic diagram of a coating device for overturned formed fiber container according to the disclosure. Fiber containers mentioned here refer to containers such as dishes, bowls, pots and bottles molded from paper pulp, which have a bottom, a side wall around the bottom, an opening above the side wall, and a rim crimping outwards around the opening. The following and the attached drawings take a circular fiber basin as an example, but the coating device of the disclosure could be other fiber containers.

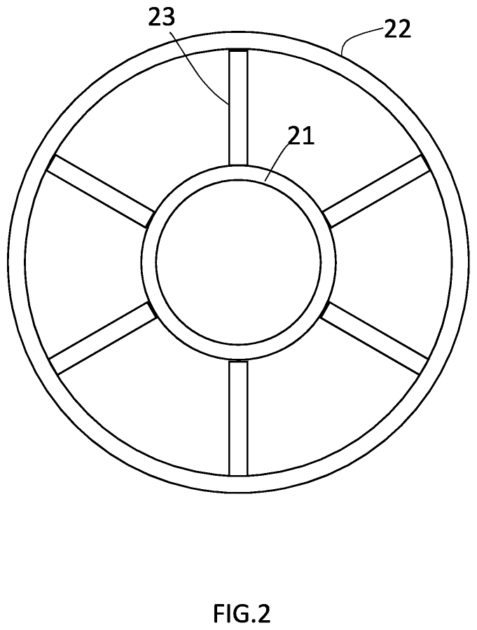

As shown in FIG. 1, the coating device comprises a support 2 for supporting an overturned fiber container 1, and the upper surface of the support 2 supports a rim 11 of the fiber container 1. As shown in the top view of the support 2 in FIG. 2, the support has an inner ring 21 and an outer ring 22 spaced apart from each other, and a plurality of connecting rods 23 are arranged between the inner ring 21 and the outer ring 22. FIG. 2 shows six connecting rods 23, which are symmetrically distributed about the coincident center of the inner ring 21 and the outer ring 21. Other numbers and layouts of the connecting rods are also feasible and fall within the protection scope of the disclosure. Referring to FIG. 1, the opening of a fiber container 1 to be treated is placed downward, with its rim 11 resting on a plurality of connecting rods 23 and its bottom 12 being on the top. The coating device further includes a pressing block 3 for pressing the bottom 12 of the fiber container 1 from the upper side. The pressing block 3 is connected with a positioning rod 31 which can be driven to move up and down. Once the positioning rod 31 moves down to position, the pressing block 3 presses the fiber container 1, such that the rim 11 presses the support 2 to generate sufficient friction between the rim 11 and the support 2, and therefore, the fiber container 1 can rotate synchronously with the support 2. Moreover, the press block 3 is configured to be rotatable, and sufficient friction can be generated between the bottom 12 and the press block 3, so that the press block 3 can rotate synchronously with the fiber container 1. Once the positioning rod 31 moves up to position, the pressing for the pressing block 3 is released. At this time, the fiber container 1 can be moved away from the support 2 and transferred to subsequent station, or transferred to the support 2 from the previous station.

As shown in FIG. 1, the spray nozzle 4 is arranged below the inside of the overturned fiber container 1, especially between the pressing block 3 and the support 2. The spray nozzle 4 is mounted on a rod 41 which extends downward through the inner ring 21 of the support 2. During the coating operation, the spray nozzle 4 sprays the solution around, and the atomized solution adheres to the inner wall of the fiber container 1. The support 2 drives the fiber container 1 to rotate at a high speed and to generate centrifugal force, so that the solution adhered to the inner wall of the fiber container 1 spreads out and forms a uniform film. During this process, since the fiber container 1 surrounds the spray nozzle 4, the solution sprayed by the spray nozzle 4 will be blocked by the inner wall of the fiber container 1 and will not spread to the outside, and thus, the problem that the solution pollutes the environment is eliminated. Moreover, there is no need to provide a closed chamber around as in the prior art, and thus the occupied area is greatly reduced.

The outer ring 22 of the support 2 is installed in position by the upper gland 51 and the abutment 52 below, and the inner side of the abutment 52 is provided with a groove for accommodating the outer ring 22. The abutment 52 is installed above the outer periphery of the guide plate 6. The guide plate 6 has a central hole 61 and a guide surface 62 inclined downward toward the central hole 61 for guiding the solution to flow toward the central hole 61. Excess solution sprayed on the inner wall of the fiber container 1 will fall onto the guide plate 6 due to the gravity, flow downwards through the central hole 61, and finally be collected by the collecting device 20, and thus, the solution can be recycled and the economic benefit can be improved. In addition, a baffle plate 7 could be installed between the guide plate 6 and the abutment 52; the center of the baffle plate 7 has an opening, and will not prevent the solution from falling down from the fiber container 1. The baffle plate 7 covers the outer part of the guide surface 62 of the guide plate 6, and can prevent the solution from splashing upward along the guide surface 62 under high-speed rotation.

As shown in FIG. 1, a rotor cylinder 8 is installed below the guide plate 6. The rotor cylinder 8 has an inner hole 81, which abuts the central hole 61 of the guide plate 6. The rod 41 of the top-mounted spray nozzle 4 extends downward through the inner hole 81 of the rotor cylinder 8. A tooth ring 83 is installed on the upper side of the outer wall 82 of the rotor cylinder 8. The tooth ring 83 can be driven by a driving motor 84 via a toothed belt 85, so as to drive the rotor cylinder 8 to rotate, and then, the rotor cylinder 8 drives the upper guide plate 6, the support 2, the fiber container 1 and the pressing block 3 to rotate synchronously. The lower part of the outer wall 82 of the rotor cylinder 8 is mounted on the mounting plate 9 by a bearing 86, and the mounting plate 9 is mounted on the operating table 10 below. The bearing 86 can support the rotor cylinder 8 to rotate relative to the operating table 10 and also support the rotor cylinder 8 in the vertical direction.

A collecting device 20 is installed on the lower surface of the operating table 10. The internal volume of the collecting device 20 communicates with the inner hole 81 of the rotor cylinder 8, so that the excess solution on the surface of the fiber container 1 can be collected by the collecting device 20. In addition, the lower end of the rod 41 of the spray nozzle 4 is arranged inside the collecting device 20, and it is fixedly installed to the operation table 10 via the connector 42. A pipeline for supplying solution to the spray nozzle 4 is arranged inside the rod 41, and the pipeline is communicated with the collecting device 20 through a pump 43. The pump 43 can pump the solution collected by the collecting device 20 and supply it to the spray nozzle 4 for spraying through the pipeline of the rod 41, and therefore, the solution could be recycled and the economic benefit could be improved.

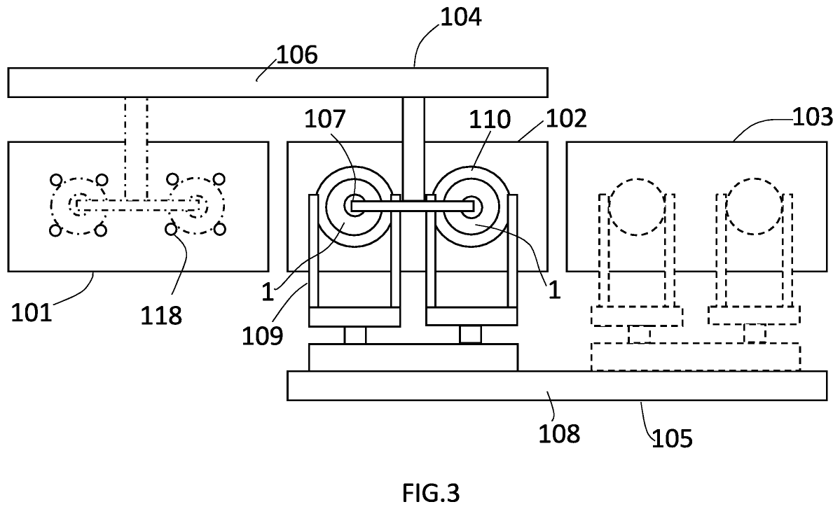

FIG. 3 shows a schematic diagram of the coating line for fiber containers of the disclosure. The coating line has an upstream station 101, a coating station 102 and a downstream station 103, which are sequentially arranged. The coating line also includes an input device 104 for moving fiber containers from the upstream station 101 to the coating station 102, and an output device 105 for moving fiber containers from the coating station 102 to the downstream station 103. The input device 104 includes a vacuum chuck 107, which can move along the first rail 106 and suck the bottom of the overturned fiber container 1 so as to move the fiber container 1. The coating station 102 is provided with the coating device mentioned above. The coating device can spray the solution from below the overturned fiber container 1, and then rotate the fiber container 1 at high speed to coat the solution on the inner surface of the fiber container 1 to form an isolation film. The output device 105 includes a mechanical arm 109 that can move along the second rail 108. The mechanical arm 109 can clamp the fiber container from both sides, and then rotate 180 degrees to ensure the fiber container enter the downstream station 103 with its opening facing upward. It is advantageous for the output device 105 to utilize the mechanical arm 109 instead of the vacuum chuck, to avoid the vacuum chuck sucking the uncured solution inside the fiber container 1 and affecting the coating quality.

In some embodiments, the upstream station can be provided with a feeding conveyor belt to continuously convey the fiber containers to be coated and processed. The downstream station can also be equipped with a discharge conveyor belt to continuously output the coated fiber containers to the downstream drying equipment. By making the devices cooperate with each other, continuous production can be realized.

In some embodiments, the upstream station may be provided with a stacking mechanism 118. As shown in FIG. 3, the stacking mechanism 118 may include a plurality of (for example, four) upright posts, and a plurality of vertically stacked fiber containers are stored in the space between the upright posts. The vacuum chuck 107 can suck one uppermost fiber container from the stack at one time and transfer it to the downstream spraying station 102 for spraying treatment. Advantageously, the plurality of upright posts can be biased inward, and the stack of fiber containers can be pressed from the periphery, so that the fiber containers are always in the correct position, and accurate suction can be realized.

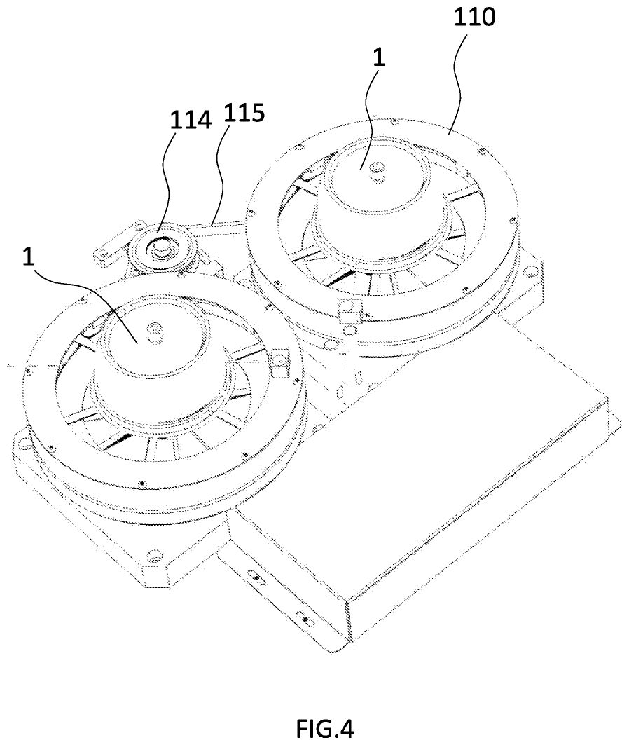

The coating line shown in FIG. 3 adopts a double-station coating device 110, that is, it can coat two fiber containers 1 at the same time, to improve production efficiency. Correspondingly, the input device 101 has two vacuum chucks working synchronously, and the output device 103 has two mechanical arms working synchronously. FIG. 4 shows a perspective view of this two-station coating device 110, which has two groups of the coating devices mentioned above, and their rotor cylinders rotate synchronously to drive the respective fiber containers 1 to rotate synchronously. It should be noted that the double-station coating device is only one possible embodiment, and the disclosure is not limited to this. One, three or more coating devices mentioned above can be arranged at the coating station as required.

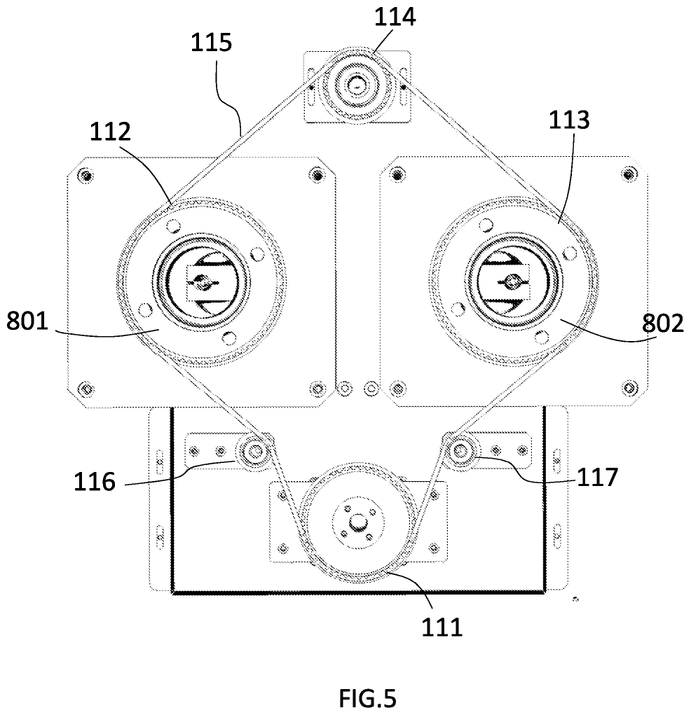

FIG. 5 shows a cross-sectional view of FIG. 4, showing the structure of a driving mechanism for driving two rotor cylinders to rotate synchronously. The driving mechanism has a driving gear 111 driven by a driving motor, a first gear ring 112 located on the first rotor cylinder 801, a second gear ring 113 located on the second rotor cylinder 802, and a primary guide wheel 114. The annular toothed belt 115 surrounds the driving gear 111, the first gear ring 112, the primary guide wheel 114 and the second gear ring 113 sequentially. In addition, between the first ring gear 112 and the driving gear 111, a first auxiliary guide wheel 116 is provided. Between the second ring gear 113 and the driving gear 111, a second auxiliary guide wheel 117 is provided. The two auxiliary guide wheels and the primary guide wheel 114 are located on the opposite sides of the toothed belt 115, and they cooperate to keep the toothed belt 115 in a proper tension state. By means of this design, the driving gear 114 can smoothly drive the first rotor cylinder 801 and the second rotor cylinder 801 to rotate synchronously. The above-mentioned toothed belt and tooth ring structure is highly expandable. For example, if the coating line has other coating devices (for example, three), the toothed belt 115 can be set to surround the tooth rings on the rotor cylinders of the coating devices at each station to make them rotate synchronously.

This paper describes the exemplary implementation of the disclosure in detail with reference to the preferred embodiments. However, it can be understood by those skilled in the art that various variations and modifications can be made to the above specific embodiments without departing from the concept of the disclosure, and various technical features and structures proposed by the disclosure can be combined in various ways without exceeding the protection scope of the disclosure, which is determined by the appended claims.

1. A coating device for overturned formed fiber container, the coating device comprising:
a support configured to support a rim of a container at an upper surface of the container;
a pressing block disposed above the support and configured to press the container at a bottom surface of the container; and
a spray nozzle configured to spray a solution on an inner wall of the container; and
wherein, the support is configured to rotate relative to the spray nozzle so as to rotate the container.

2. The coating device according to claim 1,
wherein the support comprises an inner ring, an outer ring, and a plurality of connecting rods connecting the inner ring and the outer ring; and
wherein the plurality of connecting rods are configured to support the rim of container.

3. The coating device according to claim 1, further comprising:
a guide plate disposed below the support and configured to rotate synchronously with the support; and
wherein the guide plate has a central hole and a guide surface inclined downward towards the central hole.

4. The coating device according to claim 3, further comprises:
a baffle plate disposed between the support and the guide plate and covering an outside part of the guide surface.

5. The coating device according to claim 3, further comprises:
a rotor cylinder disposed below the guide plate and fixed to the guide plate; and
wherein the rotor cylinder includes an inner hole in communication with the central hole of the guide plate; and
wherein the rotor cylinder is rotatably supported on an operating table.

6. The coating device according to claim 5,
wherein an upper part of the outer wall of the rotor cylinder is provided with a tooth ring which is connected to a driving motor through a toothed belt; and
wherein a lower part of the outer wall of the rotating cylinder is provided with a bearing, located between the rotor cylinder and a mounting plate fixed to the operating table, and wherein the bearing bears the rotor cylinder to rotate relative to the mounting plate and also supports the rotor cylinder in a vertical direction.

7. The coating device according to claim 5, further comprises:
a collecting device installed onto the lower surface of the operating table, wherein an internal volume of the collecting device is in communication with the inner hole of the rotor cylinder; and
a pump configured to pump a solution in the collecting device to the spray nozzle.

8. The coating device according to claim 7, further comprises:
a connector located inside the collecting device and having a first end connected to the operating table and a second end connected to a lower end of a rod connected to the spray nozzle, and
wherein the rod extends through the inner hole of the rotor cylinder.

9. A coating line for an overturned formed fiber container, the coating line comprising:
an upstream station, a coating station, and a downstream station;
an input device configured to move an overturned formed fiber container from the upstream station to the coating station; and
an output device configured to move the overturned formed fiber container from the coating station to the downstream station; and
wherein the coating device according to claim 1 is disposed at the coating station.

10. The coating line according to claim 9,
wherein the input device includes a vacuum chuck configured to transfer, via vacuum pressure, an overturned formed fiber container from a stack of overturned formed fiber containers stored in a stacking mechanism; and
wherein the output device includes a mechanical arm configured to clamp an overturned formed fiber container, transfer an overturned formed fiber container, overturn an overturned formed fiber container, or any combination thereof.
